(19) United States
(12) Patent Application Publication
(10) Pub. No.: US 2008/0211648 A1
(43) Pub. Date: Sep. 4, 2008

(54) Method for Exchanging Data

(76) Inventor: Michael Salm, Peterzell (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/913,908

(22) PCT Filed: May 4, 2006
(86) PCT No.: PCT/EP06/62036

§ 371 Date: Nov. 8, 2007

(30) Foreign Application Priority Data
May 12, 2005 (DE) 10 2005 022 111.4

(51) Int. Cl. B60Q 1/00

(52) U.S. Cl. 340/441

(57) ABSTRACT

In a method for exchanging data between a tachograph (DTCO) and a terminal device (CALTEST), the data transmission protocol provides for the terminal device (CALTEST) to cause the tachograph (DTCO) to perform a service by indicating at least one service identification (SID). The method further provides for transmitting data in such a way that a flexible compatibility of the tachograph is obtained. The tachograph (DTCO) encompasses an allocation of internal service identifications (IIDS) to external service identifications (EIDS), the external service identifications (EIDS) are used during data exchange with the terminal device (CALTEST), and external service identifications (EIDS) of incoming data are exchanged with matching internal service identifications (IIDS) according to the allocation (mapping list MAP) by a communication module (COMM).

### CROSS-REFERENCE TO RELATED APPLICATIONS

This application is a U.S. national stage application of International Application No. PCT/EP2006/062036 filed May 4, 2006, which designates the United States of America, and claims priority to Germany application number 10 2005 022 111.4 filed May 12, 2005, the contents for which are hereby incorporated by reference it their entirety.

### TECHNICAL FIELD

The invention relates to a method for exchanging data between a tachograph and a connecting device, the tachograph having a data-transmitting connection to the connecting device and the data being transmitted in accordance with a data transmission protocol which provides for the connecting device to cause the tachograph to perform a service by specifying at least one service identifier.

### BACKGROUND

The above methods, in which service identifiers in particular value ranges are assigned to particular groups of services of the tachograph, are known in accordance with EEC Regulation No. 3821/85 and ISO 14229, ISO 14230 and ISO 16844. In this case, a service is to be understood as meaning, for example, the operation of reading or writing particular data in a memory of the tachograph. For example, the current date can be read from a memory area of the tachograph using the connecting device. For this purpose, the connecting device transmits a data block to the tachograph, said data block comprising, inter alia, the service identifier intended for said tachograph.

A system supplier supplies commercial vehicle manufacturers with the tachographs, said commercial vehicle manufacturers installing and calibrating and subsequently testing the installed device. For this purpose, the connecting device is connected to the tachograph using a data-transmitting connection and the necessary parameters are input and tested by transmitting various data blocks comprising service identifiers. In this case, it is absolutely necessary for the connecting device to be matched to the type of tachograph to be configured in a functioning manner. However, particularly when using tachographs from different manufacturers, the use of the same connecting device may result in difficulties with regard to compatibility.

### SUMMARY

According to various embodiment, a method for transmitting data of the type mentioned initially can be developed in such a manner that flexible compatibility of the tachograph is achieved. According to an embodiment of a method and a system for exchanging data between a tachograph and a connecting device, the tachograph having a data-transmitting connection to the connecting device, the method may comprise the steps of and the system may be operable to transmit the data in accordance with a data transmission protocol which provides for the connecting device to cause the tachograph to perform a service by specifying at least one service identifier, assign internal service identifiers to external service identifiers by the tachograph, wherein the external service identifiers are used when exchanging data with the connecting device, and replace external service identifiers of incoming data with corresponding internal service identifiers in accordance with the assignment by a communication module.

According to a further embodiment, the assignment may uniquely assign an external service identifier to each internal service identifier. According to a further embodiment, the assignment may uniquely assign an internal service identifier to each external service identifier. According to a further embodiment, the assignment can be stored in an internal memory of the tachograph. According to a further embodiment, the assignment can be at least partially changed using a service. According to a further embodiment, the service identifier of the service, which can be used to change the assignment, can be designed not to be changed. According to a further embodiment, some service identifiers may comprise a main service identifier and an ancillary service identifier. According to a further embodiment, the main service identifier and the ancillary service identifier can be in the form of individually addressable fields which are combined with one another to form a service identifier. According to a further embodiment, the main service identifiers can be designed not to be changed. According to a further embodiment, only some of the ancillary service identifiers which can be assigned to particular main service identifiers can be changed. According to a further embodiment, only some of the ancillary service identifiers which can be assigned to the main service identifiers of “reading” and “writing” can be changed. According to a further embodiment, provision can be made of a service identifier which overwrites the values of the external service identifiers in the assignment with those of the internal service identifiers.

### BRIEF DESCRIPTION OF THE DRAWINGS

One special exemplary embodiment is described in more detail below with reference to a drawing. In addition to this exemplary embodiment, further designs which can be attributed to the invention come to light for a person skilled in the art. In the drawing:

FIG. 1 shows a diagrammatic illustration of one embodiment of the method according to an embodiment.

### DETAILED DESCRIPTION

According to various embodiments, the tachograph can be flexibly adapted to different connecting devices and in this way is also prepared for unforeseen changes in the technology, in particular for changes in the scope of functions. In this case, the interface or the external appearance of the tachograph can be individually configured, the internal sequences nevertheless remaining unchanged and corresponding to relevant standards. In particular, the connection of a particular connecting device may be taken into account without impairing the function of the interaction with the connected car area network, for example. Data transmission by the tachograph can be adapted to particular requirements in interaction with connecting devices without a high level of complexity.

A particularly high level of operational reliability is ensured if the assignment uniquely assigns an external service identifier to each internal service identifier. This assignment may also be advantageously stored in the memory. If only part of the internal service identifier differs from the external service identifiers, only this concordance can be stored in the memory in a more advantageous manner, in particular as regards saving storage space and computing time, with the result that there is an assignment only where there is actually a “mapping” and external service identifiers differ from internal service identifiers. These service identifiers should be replaced by the communication module when data are received while exchanging data.

The practice of uniquely assigning each external service identifier to an internal service identifier has the same effect of stabilizing operation of the arrangement.

The memory in which the assignment of the service identifiers is stored is expediently an integrated part of the tachograph and is thus supplied by the system supplier, in which case it is expedient if options for changing this assignment by the vehicle manufacturer are provided. In this case, it is expedient if the assignment can be at least partially changed using a service. This service may expediently have a service identifier in the same manner, this service identifier advantageously not being able to be changed. The static design of this service identifier is expedient insofar as at least one subsequent correction is always unproblematic in the event of an incorrect assignment.

A design of the service identifiers comprising a main service identifier and an ancillary service identifier is expedient. This makes it possible to implement a comparatively hierarchical structure of the desired functions. In this case, main service identifiers are assigned to services which regularly need further specification. For example, a main service identifier can be assigned to the service of “reading” and an ancillary service identifier can be assigned to the specification of the element at which this service is intended to be aimed, for example “date”. Ancillary service identifiers according to an embodiment expediently specify details of the main service identifier. In this case, it is expedient, in the sense of a high level of modular flexibility, if the main service identifier and the ancillary service identifier are in the form of respective individually addressable fields which are combined with one another to form a service identifier. A higher level of operational stability is achieved if the main service identifier cannot be changed. Furthermore, the risk of unstable operating states is reduced if only some of the ancillary service identifiers which can be assigned to particular main service identifiers can be changed. In this case, the main service identifiers of “reading” and “writing” may be of particular importance, with the result that only some of the ancillary service identifiers which can be assigned to these main service identifiers can be changed.

So that a standardized delivered state of the tachograph can be produced with only a low level of complexity, in particular following incorrect assignment of service identifiers, it is expedient if the values of the external service identifiers can be overwritten in the assignment with those of the internal service identifiers using a separate service identifier.

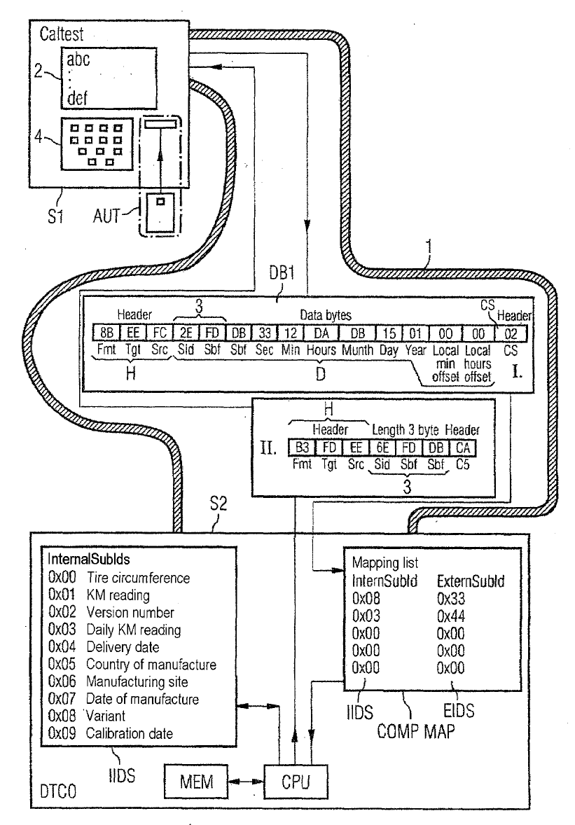

In FIG. 1, a tachograph is provided with the reference symbol DTCO and a connecting device is provided with the reference symbol CALTEST. A data-transmitting connection 1 which connects a first interface S1 of the connecting device CALTEST to a second interface S2 of the tachograph DTCO exists between the connecting device CALTEST and the tachograph DTCO.

The connecting device CALTEST has a display 2 as well as an input device 4 and a device AUT for identifying and authorizing the connecting device CALTEST or the operator. The connecting device CALTEST is used to transfer different calibration parameters to the tachograph DTCO and to carry out tests, in particular within the scope of simulations.

The tachograph DTCO has a central processor CPU which is connected to a mass memory MEM, a stored assignment of internal service identifiers IIDS, a stored assignment of external service identifiers EIDS and the second interface S2.

If a data block DB1 arrives at the second interface S2 of the DTCO during data exchange (I, II), a communication module COMM, in which a mapping list MAP comprises an assignment of internal service identifiers IIDS to external service identifiers EIDS, checks whether external service identifiers EIDS should be replaced with internal service identifiers IIDS using the assignment.

The data block DB1 comprises a header H, data D and a checksum CS which is cited at the end. The header H comprises an item of format information FMT, an item of destination information TGT and an item of source information SRC. Introducing the data D is a service identifier 3 comprising a main service identifier SID and an ancillary service identifier SBF. The ancillary service identifier SBF supplements the main service identifier SID insofar as the ancillary service identifier SBF specifies the instruction from the main service identifier SID with further details. The exemplary embodiment provides for only some of the ancillary service identifiers SBF to be allocated differently or to be able to be allocated differently in terms of internally and externally used value allocations (IIDS, EIDS) with respect to the main service identifiers SID of “reading” and “writing”. When the data block DB1 is received at the interface S2 of the tachograph DTCO, the communication module COMM replaces the external ancillary service identifier SBF with an internal ancillary service identifier using the assignment EIDS, IIDS in the mapping list MAP, with the result that the processor CPU can perform the service on the basis of the internal service identifiers IIDS. Accordingly, the processor CPU responds with the data block DB 2 (II) by accessing the main memory MEM.

What is claimed is:

1. A method for exchanging data between a tachograp and a connecting device, the tachograph having a data-transmitting connection to the connecting device, the method comprising the steps of:
transmitting the data in accordance with a data transmission protocol which provides for the connecting device to cause the tachograph to perform a service by specifying at least one service identifier,
assigning internal service identifiers to external service identifiers by the tachograph, wherein the external service identifiers are used when exchanging data with the connecting device, and
replacing external service identifiers of incoming data with corresponding internal service identifiers in accordance with the assignment by a common module.

2. The method according to claim 1, wherein the assignment uniquely assigns an external service identifier to each internal service identifier.

3. The method according to claim 1, wherein the assignment uniquely assigns an internal service identifier to each external service identifier.

4. The method according to claim 1, wherein the assignment is stored in an internal memory of the tachograph.

5. The method according to claim 1, wherein the assignment can be at least partially changed using a service.

6. The method according to claim 5, wherein the service identifier of the service, which can be used to change the assignment, cannot be changed.

7. The method according to claim 1, wherein some service identifiers comprise a main service identifier and an ancillary service identifier.

8. The method according to claim 7, wherein the main service identifier and the ancillary service identifier are in the form of individually addressable fields which are combined with one another to form a service identifier.

9. The method according to claim 1, wherein the main service identifiers cannot be changed.

10. The method according to claim 1, wherein only some of the ancillary service identifiers which can be assigned to particular main service identifiers can be changed.

11. The method according to claim 10, wherein only some of the ancillary service identifiers which can be assigned to the main service identifiers of “reading” and “writing” can be changed.

12. The method according to claim 1, wherein provision is made of a service identifier which overwrites the values of the external service identifiers in the assignment with those of the internal service identifiers.

13. A system comprising a tachograph and a connecting device, the tachograph having a data-transmitting connection to the connecting device, wherein the system is operable
to transmit data between the connecting device and the tachograph in accordance with a data transmission protocol which provides for the connecting device to cause the tachograph to perform a service by specifying at least one service identifier,
to assign internal service identifiers to external service identifiers by the tachograph, wherein the external service identifiers are used when exchanging data with the connecting device, and
to replace external service identifiers of incoming data with corresponding internal service identifiers in accordance with the assignment by a communication module.

14. The system according to claim 13, wherein the assignment uniquely assigns an internal and/or external service identifier to each internal service identifier.

15. The system according to claim 13, wherein the assignment is stored in an internal memory of the tachograph.

16. The system according to claim 13, wherein the assignment can be at least partially changed using a service.

17. The system according to claim 16, wherein the service identifier of the service, which can be used to change the assignment, cannot be changed.

18. The system according to claim 13, wherein some service identifiers comprise a main service identifier and an ancillary service identifier.

19. The system according to claim 18, wherein the main service identifier and the ancillary service identifier are in the form of individually addressable fields which are combined with one another to form a service identifier.

20. The system according to claim 13, wherein the main service identifiers cannot be changed.

21. The method according to claim 18, wherein only some of the ancillary service identifiers which can be assigned to particular main service identifiers can be changed.

22. The method according to claim 21, wherein only some of the ancillary service identifiers which can be assigned to the main service identifiers of “reading” and “writing” can be changed.

23. The method according to claim 13, wherein provision is made of a service identifier which overwrites the values of the external service identifiers in the assignment with those of the internal service identifiers.
